(19) United States
(12) Patent Application Publication
(10) Pub. No.: US 2008/0229325 A1
(43) Pub. Date: Sep. 18, 2008

(54) Method and apparatus to use unmapped cache for interprocess communication

(76) Inventor: Alexander V. Supalov, Erftstadt (DE)

Correspondence Address: INTEL CORPORATION;c/o INTELLEVATE, LLC, P.O. BOX 52050, MINNEAPOLIS, MN, 55402, US

(21) Appl. No.: 11/724,518

(22) Filed: Mar. 15, 2007

(51) Int. Cl. G06F 13/00

(52) U.S. Cl. 719/312

(57) ABSTRACT

A processing system features random access memory (RAM) and a processor. The processor features cache memory and multiple processing cores. The processor also features cache unmapping logic that can receive an unmap request calling for creation of a memory segment to be used as a shared memory segment to reside in the cache memory of the processor. The shared memory segment may facilitate interprocess communication (IPC). After receiving the unmap request, the cache unmapping logic may cause the processing system to omit the shared memory segment when writing data from the cache memory to the RAM. Other embodiments are described and claimed.

### FIELD OF THE INVENTION

The present disclosure relates generally to the field of data processing, and more particularly to methods and related apparatus to use unmapped cache for interprocess communication.

### BACKGROUND

A process in a computer system may generate multiple threads of execution (“threads”). A thread is an execution unit that includes a set of instructions to be executed by a processing unit. The term “interprocess communication” (IPC) refers to the exchange of data between two or more threads in one or more processes. Thus, despite the name, the term IPC generally pertains to communication between threads, which may also happen to belong to different processes. Some techniques for IPC includes functions or methods for (a) message passing, (b) synchronization, (c) shared memory, and (d) remote procedure calls (RPC).

Multiprocessor systems include traditional symmetric multiprocessor (SMP) systems, as well multicore systems, in which two or more cores are packaged together on the die or in the processor package. Inside a multiprocessor system, interprocess communication usually goes through the shared memory segment or directly from one process memory to another process memory.

A shared memory segment is a portion of random access memory (RAM) that can be accessed by more than one process. In a conventional processing system, the shared memory segment is written and read from user-space, without any sort of kernel-mediated synchronization. By contrast, communication directly from one process memory to another process memory typically requires the presence of a kernel agent or another special operating system (OS) extension, and a corresponding application programming interface (API).

Conventional processing systems have RAM write-back coupling, in that data which is written to cache memory eventually gets written back to RAM.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram depicting an example data processing environment; and

FIG. 2 is a flowchart depicting various aspects of an example process for using unmapped cache for interprocess communication.

### DETAILED DESCRIPTION

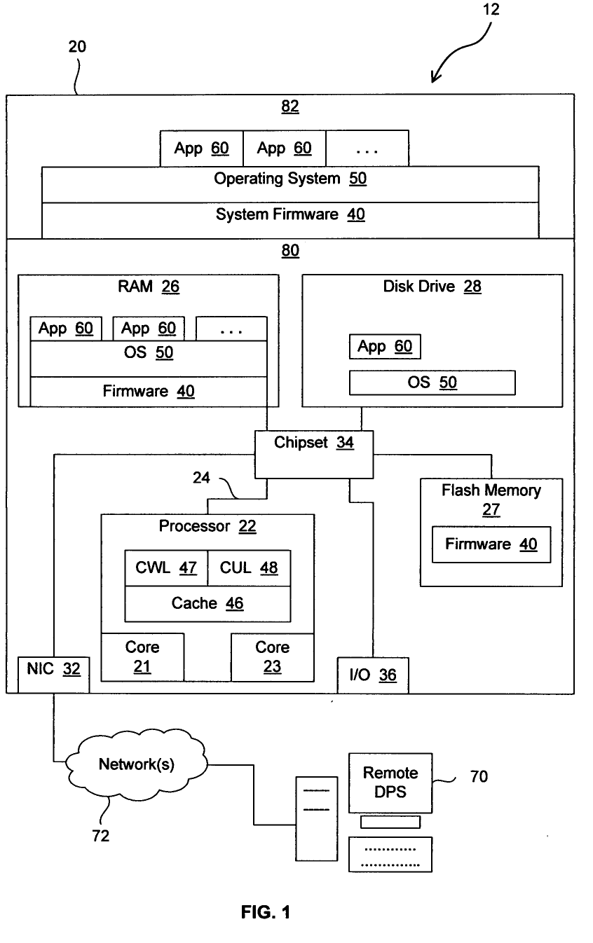

FIG. 1 is a block diagram depicting an example data processing environment 12. Data processing environment 12 includes a local data processing system 20 that includes various hardware components 80 and software components 82. The hardware components may include, for example, one or more processors or central processing units (CPUs) 22 communicatively coupled to various other components via one or more system buses 24 or other communication pathways or mediums. As used herein, the term “bus” includes communication pathways that may be shared by more than two devices, as well as point-to-point pathways.

CPU 22 may include two or more processing units, such as processing unit 21 and processing unit 23. Alternatively, a processing system may include a CPU with one processing unit, or multiple processors, each having at least one processing unit. The processing units may be implemented as processing cores, as Hyper-Threading (HT) technology, or as any other suitable technology for executing multiple threads simultaneously or substantially simultaneously.

Processor 22 may also include cache memory 46, cache write-back logic (CWL) 47, and cache unmapping logic (CUL) 48.

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers (PCs), workstations, servers, portable computers, laptop computers, tablet computers, personal digital assistants (PDAs), telephones, handheld devices, entertainment devices such as audio and/or video devices, and other devices for processing and/or transmitting information.

Processing system 20 may be controlled, at least in part, by input from conventional input devices, such as a keyboard, a pointing device such as a mouse, etc. Processing system 20 may also respond to directives received from other processing systems or other input sources or signals. Processing system 20 may utilize one or more connections to one or more remote data processing systems 70, for example through a network interface controller (NIC) 32, a modem, or other communication ports or couplings. Processing systems may be interconnected by way of a physical and/or logical network 72, such as a local area network (LAN), a wide area network (WAN), an intranet, the Internet, etc. Communications involving network 72 may utilize various wired and/or wireless short range or long range carriers and protocols, including radio frequency (RF), satellite, microwave, Institute of Electrical and Electronics Engineers (IEEE) 802.11, 802.16, 802.20, Bluetooth, optical, infrared, cable, laser, etc. Protocols for 802.11 may also be referred to as wireless fidelity (WiFi) protocols. Protocols for 802.16 may also be referred to as WiMAX or wireless metropolitan area network protocols. Information on WiMAX protocols is currently available at grouper.ieee.org/groups/802/16/published.html.

Within processing system 20, processor 22 may be communicatively coupled to one or more volatile data storage devices, such as random access memory (RAM) 26, and to one or more nonvolatile data storage devices. In the example embodiment, the nonvolatile data storage devices include flash memory 27 and hard disk drive 28. In alternative embodiments, multiple nonvolatile memory devices and/or multiple disk drives may be used for nonvolatile storage. Suitable nonvolatile storage devices and/or media may include, without limitation, integrated drive electronics (IDE) and small computer system interface (SCSI) hard drives, optical storage, tapes, floppy disks, read-only memory (ROM), memory sticks, digital video disks (DVDs), biological storage, polymer memory, etc.

As used herein, the term “nonvolatile storage” refers to disk drives, flash memory, and any other storage component that can retain data when the processing system is powered off. And more specifically, the term “nonvolatile memory” refers to memory devices (e.g., flash memory) that do not use rotating media but still can retain data when the processing system is powered off. The terms “flash memory” and “ROM” are used herein to refer broadly to nonvolatile memory devices such as erasable programmable ROM (EPROM), electrically erasable programmable ROM (EEPROM), flash ROM, etc.

Processor 22 may also be communicatively coupled to additional components, such as NIC 32, video controllers, IDE controllers, SCSI controllers, universal serial bus (USB) controllers, input/output (I/O) ports, input devices, output devices, etc. Processing system 20 may also include a chipset 34 with one or more bridges or hubs, such as a memory controller hub, an I/O controller hub, a PCI root bridge, etc., for communicatively coupling system components.

Some components, such as NIC 32, for example, may be implemented as adapter cards with interfaces (e.g., a PCI connector) for communicating with a bus. Alternatively, NIC 32 and/or other devices may be implemented as embedded controllers, using components such as programmable or non-programmable logic devices or arrays, application-specific integrated circuits (ASICs), embedded computers, smart cards, etc.

The invention is described herein with reference to or in conjunction with data such as instructions, functions, procedures, data structures, application programs, configuration settings, etc. When the data is accessed by a machine, the machine may respond by performing tasks, defining abstract data types or low-level hardware contexts, and/or performing other operations, as described in greater detail below. The data may be stored in volatile and/or nonvolatile data storage.

As used herein, the term “program” covers a broad range of software components and constructs, including applications, modules, drivers, routines, subprograms, methods, processes, threads, and other types of software components. Also, the term “program” can be used to refer to a complete compilation unit (i.e., a set of instructions that can be compiled independently), a collection of compilation units, or a portion of a compilation unit. Thus, the term “program” may be used to refer to any collection of instructions which, when executed by a processing system, perform a desired operation or operations.

The programs in processing system 20 may be considered components of a software environment 84. For instance, data storage device 28 and/or flash memory 27 may include various sets of instructions which, when executed, perform various operations. Such sets of instructions may be referred to in general as software.

As illustrated in FIG. 1, in the example embodiment, the programs or software components 82 may include system firmware 40, an OS 50, and one or more applications 60. System firmware 40 may also be referred to as a basic input/output system (BIOS) 40. System firmware 40 may also include boot firmware for managing the boot process, as well as runtime modules or instructions that can be executed after the OS boot code has been called. System firmware 40 may also include one or more routines for updating control logic such as microcode in processor 22. For instance, firmware 40 may include a program to configure programmable logic in processor 22 to serve as CUL 48. Alternatively, CUL 48 may be more or less permanently built in to processor 22.

As indicated above, shared memory segments may be used for interprocess communication (IPC).

In the embodiment of FIG. 1, CUL 48 allows a program to define a shared memory segment (or multiple shared memory segments) in a manner that allows data to be saved to cache memory 46, while preventing CWL 47 from copying that data from cache to the physical RAM. For instance, when CUL 48 has been used to define a shared memory segment, processing system 20 may not associate the cache memory locations or addresses for that shared memory segment to any area of RAM 26. The relevant portion of the cache memory thus is not associated with any area of the physical RAM.

In one example embodiment, to create a shared memory segment that is not mapped to RAM 26, a predetermined flag, parameter, or reserved word is passed to a memory map system call (e.g., mmap(2)), along with size information and any other necessary information. Thus, programs may easily place shared memory segments into unmapped cache. For purposes of this disclosure, the term “unmapped cache” is used to refer to a shared memory segment that can be accessed in cache memory, even though it is not mapped to RAM. Unmapped cache may also be referred to as a shared, unmapped memory segment.

The instruction or instructions that are used to create a shared, unmapped memory segment may be referred to as an unmap request. Other techniques may be used to implement unmap requests in alternative embodiments, including without limitation (a) a system call, (b) a special, dedicated, unmap instruction, (c) a new prefix or suffix for an existing instruction, (d) a control register that can be set to a particular value to cause the desired behavior when a conventional instruction (e.g., move or MOV) is executed.

In the embodiment of FIG. 1, chipset 34 includes a memory controller, and CUL 48 is implemented as hardware or software control logic in processor 22. In alternative embodiments, a CUL may be implemented as part of a memory controller on the processor, as part of an external memory controller, as part of external cache, or as part of any other suitable component. In an embodiment with external cache organized like an I/O device, the CUL could be invoked by writing to an address in the memory space or writing to a port, possibly in a manner similar to that used to control a graphics processor. A CUL implemented as part of an internal or external memory controller could reject write-back attempts for unmapped memory segments.

In the embodiment of FIG. 1, CUL 48 suspends or eliminates RAM write-back coupling for the specified memory segment or segments. This means that any data written into those areas of cache memory is not written to RAM 26 at all. This may be appropriate for IPC, because the data put into the shared memory segment is transient in nature.

If the communicating processes are assigned to different processing units, cache memory that is shared by those processing units may be used for the unmapped cache. If the communicating processes are assigned to a single processor, the unmapped cache may reside in cache memory which is not accessible to other processors.

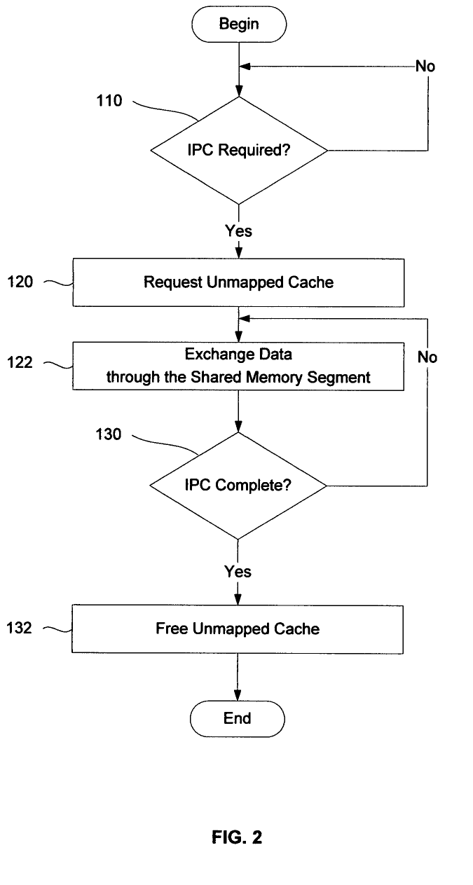

FIG. 2 is a flowchart depicting various aspects of an example process for using unmapped cache for interprocess communication. The example process begins with a process executing on one of the processing units (e.g., processing unit 21) in processing system 20. As indicated at blocks 110 and 120, when the process determines that IPC is required, the process requests a segment of unmapped cache to be used as a shared memory segment. For instance, the process may map a segment of unmapped cache to the process' memory space by executing a particular instruction (e.g., mmap(2)) with a particular flag for invoking the unmap option (e.g., MAP_UNMAPPED_CACHE). Thus, one example instruction format could be “mmap( . . . , MAP_UNMAPPED_CACHE, . . . ),” where the ellipses may represent conventional parameters, such as segment size, etc.

Other processes that want to communicate with the given process through the unmapped cache need to perform similar actions, asking for an unmapped cache to be allocated. Common means of associating different memory segments, for example, the use of identical or similar names or labels for the unmapped cache segments, can be used to associate with each other the unmapped cache segments created by different processes. For instance, to enable communications between a first thread and a second thread, the first thread could allocate unmapped cache with the segment name “my_cache_segment_{—}1”, and the second thread could allocate unmapped cache with the same segment name. OS 50 could then enable the first and second threads to share data in that segment, while CUL 48 could prevent that data from being written back to RAM 26. This name should be unique for the pair (or group) of processes that wants to communicate via this unmapped cache segment. Also, if unmapped cache is used within one address space (e.g., between two threads in the same process), only one of the threads needs to call mmap( ), and no special operations are necessary for unmapping cache by the other thread.

Once the unmapped cache memory segment has been established, the process may use that memory segment to communicate with one or more additional processes, as indicated at block 120. For instance, the first process could save data to the unmapped cache, and the second process could read data from the unmapped cache. Processes may use any suitable message passing technique or techniques to coordinate access to the unmapped cache.

As depicted at block 130 and 132, once the first process determines that no further IPC is required, the first process may free the unmapped cache, for example, through the munmap(2) system call.

In one embodiment, the unmapped cache uses a more or less conventional double buffering algorithm, which may result in bandwidth higher than that achieved through the use of the direct interprocess memory copy via a special kernel agent or another OS extension. For instance, the double buffering may asymptotically achieve full memory bandwidth. Furthermore, the absence of the RAM write-back and bus contention may improve bandwidth for medium-sized messages. In addition, the use of the unmapped cache for IPC may result in lower message latency, due to the elimination of the RAM write-back delay.

The embodiments described above may eliminate the extra latency and bus traffic required to write back into RAM data that is essentially transient in nature. The embodiments may eliminate the need for a special kernel agent or OS extension beyond, for instance, a trivial extension of the mmap(2) system call that can be standardized across different OSs.

As has been described, at least one embodiment allows processes in a processing system to conduct IPC via cache memory, while keeping the processing system from writing the associated cache data back into RAM. Accordingly, message passing transactions may be completed without causing memory bus traffic.

In light of the principles and example embodiments described and illustrated herein, it will be recognized that the described embodiments can be modified in arrangement and detail without departing from such principles. For instance, although one embodiment is described above as using a hard disk and flash memory as nonvolatile storage, alternative embodiments may use only the hard disk, only flash memory, only some other kind of nonvolatile storage, or any suitable combination of nonvolatile storage technologies.

Also, although the foregoing discussion has focused on particular embodiments, other configurations are contemplated as well. Even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, processes that use the same operations in a different sequence, and processes in which the individual operations disclosed herein are combined, subdivided, or otherwise altered.

Alternative embodiments of the invention also include machine accessible media encoding instructions for performing the operations of the invention. Such embodiments may also be referred to as program products. Such machine accessible media may include, without limitation, storage media such as floppy disks, hard disks, CD-ROMs, ROM, and RAM; and other detectable arrangements of particles manufactured or formed by a machine or device. Instructions may also be used in a distributed environment, and may be stored locally and/or remotely for access by single or multi-processor machines.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. The hardware, software, or combinations of hardware and software for performing the operations of the invention may also be referred to as logic or control logic.

In view of the wide variety of useful permutations that may be readily derived from the example embodiments described herein, this detailed description is intended to be illustrative only, and should not be taken as limiting the scope of the invention. What is claimed as the invention, therefore, is all implementations that come within the scope and spirit of the following claims and all equivalents to such implementations.

What is claimed is:

1. A method, comprising:
determining that interprocess communication (IPC) is to be performed between a first thread and a second thread in a processing system;
receiving, at unmapping logic of the processing system, an unmap request from the first thread, wherein the unmap request calls for creation of a memory segment to be used as a shared memory segment to reside in cache memory of the processing system; and
after the unmapping logic receives the unmap request, omitting the shared memory segment when writing data from the cache memory to random access memory (RAM) in the processing system.

2. A method according to claim 1, further comprising:
executing an instruction to indicate that data from the shared memory segment is not to be written back to the RAM from the cache memory.

3. A method according to claim 1, further comprising:
executing a memory map instruction with a parameter to indicate that data from the shared memory segment is not to be written back to the RAM from the cache memory.

4. A method according to claim 1, further comprising:
in response to determining that IPC is to be performed, executing an instruction to indicate that data from the shared memory segment is not to be written back to the RAM from the cache memory.

5. A method according to claim 1, further comprising:
in response to determining that IPC is to be performed, executing a memory map instruction with a parameter to indicate that the shared memory segment is not to be mapped to the RAM.

6. A method according to claim 1, wherein:
the first thread executes in a processor of the processing system; and
the unmapping logic resides in the processor.

7. A method according to claim 1, wherein the unmapping logic prevents data in the shared memory segment of the cache memory from being written back to the RAM of the processing system, in response to the unmap request.

8. A method according to claim 1, further comprising:
receiving, from the first thread, a label for the shared memory segment; and
providing the second thread with access to data in the shared memory segment, in response to an operation of the second thread that uses the label.

9. A processor, comprising:
multiple processing cores operable, when the processor has been installed in a processing system with random access memory (RAM), to communicate with the RAM;
cache memory responsive to at least one of the processing cores; and
cache unmapping logic operable to perform operations comprising:
receiving an unmap request calling for creation of a memory segment to be used as a shared memory segment to reside in the cache memory of the processor; and
after receiving the unmap request, causing a processing system to omit the shared memory segment when writing data from the cache memory to the RAM.

10. A processor according to claim 9, further comprising:
the unmapping logic operable to prevent data in the shared memory segment of the cache memory from being written back to the RAM, in response to the unmap request.

11. A processor according to claim 9, further comprising:
the cache unmapping logic operable to cause the processing system to omit the shared memory segment when writing data from the cache memory to the RAM, in response to execution of an instruction indicating that data from the shared memory segment is not to be written back to the RAM from the cache memory.

12. A processor according to claim 9, wherein the shared memory segment comprises a portion of an address space of a thread associated with one of the processing cores.

13. A processor according to claim 9, further comprising:
cache write-back logic to cause data from segments of the cache memory outside of the shared memory segment to be written to the RAM.

14. A processing system, comprising:
a processor according to claim 9; and
RAM according to claim 9.
